(19) United States
(12) Patent Application Publication
(10) Pub. No.: US 2013/0206672 A1
(43) Pub. Date: Aug. 15, 2013

(54) MEMBRANE SEPARATION ASSEMBLIES

(71) Applicants: John R. Harness, Elgin, IL (US); Christopher M. Dyszkiewicz, Burbank, IL (US); Tom Cnop, Brussels (BE); Bhargav C. Sharma, Niles, IL (US); Pengfei Chen, Des Plaines, IL (US)

(72) Inventors: John R. Harness, Elgin, IL (US); Christopher M. Dyszkiewicz, Burbank, IL (US); Tom Cnop, Brussels (BE); Bhargav C. Sharma, Niles, IL (US); Pengfei Chen, Des Plaines, IL (US)

(73) Assignee: UOP LLC, Des Plaines, IL (US)

(21) Appl. No.: 13/372,283

(22) Filed: Feb. 13, 2012

(51) Int. Cl. B01D 63/00

(52) U.S. Cl. 210/321.72

(57) ABSTRACT

Disclosed are membrane separation assemblies. The membrane separation assemblies include a plurality of membrane separation modules configured into an array, each module of the plurality of membrane separation modules includes a plurality of membrane elements configured for separating a feed flow into a residual flow and a permeate flow. The membrane separation assemblies also include one or two feed headers configured for supplying the feed flow to the plurality of membrane separation modules and one or two residual headers configured for directing the residual flow away from the plurality of membrane separation modules. Further, the membrane separation assemblies include a permeate flow directing system for directing the permeate flow external to the plurality of membrane separation modules. The plurality of membrane separation modules configured into the array are directly and fluidly coupled to one another.

### TECHNICAL FIELD

The present invention relates generally to membrane separation assemblies for fluid separation and, more particularly, to membrane separation assemblies having multiple membrane tubes assembled in a direct-coupled arrangement.

### BACKGROUND

A variety of commercial processes rely on the use of fluid separation techniques in order to separate one or more desirable fluid components from a mixture. In particular, various such processes may involve the separation of liquid mixtures, the separation of vapors or gases from liquids, or the separation of intermingled gases. For example, in the production of natural gas, it is typically necessary for the producer to remove carbon dioxide, hydrogen sulfide, helium, water and nitrogen from natural gas in order to meet both government and industrial regulatory requirements. It is also typically desirable in many chemical processes for hydrogen to be removed and recovered from gaseous process streams.

The use of membranes for fluid separation processes has achieved increased popularity over other known separation techniques. Such membrane separations are generally based on relative permeabilities of various components of the fluid mixture, resulting from a gradient of driving forces, such as pressure, partial pressure, concentration, and/or temperature. Such selective permeation results in the separation of the fluid mixture into portions commonly referred to as “residual” or “retentate”, e.g., generally composed of components that permeate more slowly; and “permeate”, e.g., generally composed of components that permeate more quickly.

Separation membranes are commonly manufactured in a variety of forms, including flat-sheet arrangements and hollow-fiber arrangements, among others. In a flat-sheet arrangement, the sheets are typically combined into a spiral wound element. An exemplary flat-sheet, spiral-wound membrane element 100, as depicted in FIG. 1, includes two or more flat sheets of membrane 101 with a permeate spacer 102 in between that are joined, e.g., glued along three of their sides to form an envelope 103, i.e., a “leaf”, that is open at one end. The envelopes can be separated by feed spacers 105 and wrapped around a mandrel or otherwise wrapped around a permeate tube 110 with the open ends of the envelopes facing the permeate tube. Feed gas 120 enters along one side of the membrane element and passes through the feed spacers 105 separating the envelopes 103. As the gas travels between the envelopes 103, highly permeable compounds permeate or migrate into the envelope 103, indicated by arrow 125. These permeated compounds have only one available outlet: they must travel within the envelope to the permeate tube 110, as indicated by arrow 130. The driving force for such transport is the partial pressure differential between the low permeate pressure and the high feed pressure. The permeated compounds enter the permeate tube 110, such as through holes 111 passing through the permeate tube 110, as indicated by arrows 140. The permeated compounds then travel through the permeate tube 110, as indicated by arrows 150, to join the permeated compounds from other membrane elements that may be connected together in a multi-element assembly. Components of the feed gas 120 that do not permeate or migrate into the envelopes, i.e., the residual, leave the element through the side opposite the feed side, as indicated by arrows 160.

As depicted in FIG. 2, individual membrane elements 100 are typically assembled into element arrangements and are typically inserted into modules or housings 200, e.g., a tube 201 containing a plurality of membrane elements 100. Each module 200 has an input (e.g., feed) stream 210 that enters through a feed port 211, an output or residual stream 220 that contains the substances which did not permeate through the membrane separation element and that exit through a residual port 221, and a permeate stream 230 that contains the substances that permeate through, the membrane separation element and that exit through a permeate port 231 at one or both ends of the permeate tube 110. The tube 201 can range in size from about 6 inches to about 24 inches in diameter, and is typically about 8 or about 12 inches in diameter. The ports 211, 221, and 231 can range in size from about 1 inch to about 4 inches in diameter, and are typically about 2 or 3 inches in diameter. Membrane modules or housings can be configured with a single feed, single residual and single permeate connection. Alternative arrangements can have two feed connections, two residual connections or two permeate connections in various combinations. Feed and residual connections can also be located in the center of the tube in other combinations. The tube 201 and port elements 211, 221, and 231 are conventionally made of steel, a relatively heavy metal, to withstand the pressures encountered during operations which are typically from about 300 psig to about 1,500 psig or higher.

In view of increased demand for product gases such as sweetened natural gas and purified gases such as hydrogen, carbon dioxide, and hydrogen-carbon monoxide mixtures the current market for gas separation membrane systems has moved toward larger installations. One approach to meet such increased demand is to incorporate membrane modules having an increased diameter to accommodate higher fluid flow rates. Alternatively, such larger installations may incorporate more membrane modules to meet process specifications. For example, as depicted in FIG. 3, modules 200 can be employed in an interconnected group of parallel modules, referred to as an “array” 300. An installation may have from at least two up to more than a hundred modules 200 in an array 300.

Arrays currently known in the art, for example as depicted in FIG. 3, are configured with the modules 200 oriented horizontally, in a series of vertically stacked rows. As shown, twelve horizontally oriented modules 200 are included in each of four vertically stacked rows. For directing the flows of the various fluids, arrays include a feed flow directing system for directing the feed flow external to the membrane separation modules, a residual flow directing system for directing the residual flow external to the membrane separation modules, and a permeate flow directing system for directing the permeate flow external to the plurality of membrane separation modules. As part of the feed flow directing system, each row includes a feed header 310 positioned above (or below) the row, and configured in an orientation that is also horizontal, but perpendicular to the orientation of the modules 200. As such, the feed header 310 for each row can be operatively coupled to the feed port 211 of each module 200 to supply feed flow thereto. As part of the residual flow directing system, each row further includes a residual header 320 positioned below (or above) the row, and configured in an orientation that is also horizontal, but perpendicular to the orientation of the modules 200. As such, the residual header 320 for each row can be operatively coupled to the residual port 221 of each module 200 to remove residual flow therefrom. Further still, as part of the permeate flow directing system, each row includes a permeate header 330 positioned at the end of the row, and configured in an orientation that is also horizontal, but perpendicular to the orientation of the modules 200. As such, the permeate header 330 for each row can be operatively coupled to the permeate port 231 of each module 200 to remove permeate flow therefrom. The feed 310, residual 320, and permeate 330 headers for each row are conventionally between about 4 inches and about 16 inches in diameter, and are typically made of steel as well.

An array 300 as depicted in FIG. 3 further includes, as part of the feed flow directing system, a main feed header 315, as part of the residual flow directing system, a main residual header 325, and as part of the permeate flow direction system, a main permeate header 335. Each of the main feed 315, residual 325, and permeate 335 headers are oriented vertically to operatively connect with each of the row feed headers 310, residual headers 320, and permeated headers 330, respectively. Each of the main feed 315, residual 325, and permeate 335 headers conventionally have a diameter that is larger than the respective row headers 310, 320, and 330, for example, between about 6 inches and 30 inches, to accommodate the flow of each row header 310, 320, and 330, and are typically made of steel as well.

The spacing between the feed headers 310 and each row of modules 200 is conventionally between about 2-4 inches. Similarly, the spacing between the residual headers 320 and each row of modules 200 is about 2-4 inches. As such, accounting for the diameter of each of the feed 310 and residual 320 row headers, the diameter of the modules 200, the spacing between the modules 200 and the headers 310, 320, and various connection components, one example of an array 300 including four rows of modules 200, as shown in FIG. 3, would conventionally require a vertical length 350 of about 150 inches or more for installation. In many instances, this vertical spacing requirement makes manufacturing, transport and installation difficult and costly. For example, at offshore petrochemical processing facilities (fixed offshore platforms, FPSO, FLNG, etc.), space and weight are at a premium, and the vertical requirements of conventional arrays detrimentally restrict the number of arrays that can be installed, thereby limiting the processing capabilities of the offshore facility.

Thus, there is a need for membrane separation assemblies that incorporate an increased number of membrane modules in a given space. Further, there is a need for membrane separation assemblies having sufficiently increased process capacity that are desirably less cumbersome and/or less expensive to manufacture, install and maintain. Still further, there is a need for membrane separation assemblies having simplified process fluid stream connections that reduce the number of heavy steel components required in the assembly. These and other desirable features and characteristics will become apparent from the subsequent detailed description and the appended claims, taken in conjunction with the accompanying drawings and the foregoing technical field and background.

### BRIEF SUMMARY

Membrane separation assemblies are provided herein. In an exemplary embodiment, a membrane separation assembly includes a plurality of membrane separation modules, each module of the plurality of membrane separation modules including a plurality of membrane elements configured for separating a feed flow into a residual flow and a permeate flow, wherein the plurality of membrane separation modules are arranged into between two and twenty rows, each row comprising a plurality of membrane separation modules, and wherein each of the plurality of membrane separation modules in a row are oriented parallel to one another. The assembly may further include a feed flow directing system for directing the feed flow external to the membrane separation modules, the feed flow directing system including one or two feed headers configured for supplying the feed flow to the plurality of membrane separation modules. The assembly may further include a residual flow directing system for directing the residual flow external to the plurality of membrane separation modules, the residual flow directing system including one or two residual headers configured for directing the residual flow away from the plurality of membrane separation modules. Further, the assembly may include a permeate flow directing system for directing the permeate flow external to the plurality of membrane separation modules on one or both ends of the membrane separation modules. At least two of the rows are directly and fluidly coupled with one another.

In another exemplary embodiment, a membrane separation assembly includes a plurality of membrane separation modules configured into an array, each module of the plurality of membrane separation modules comprising a plurality of membrane elements configured for separating a feed flow into a residual flow and a permeate flow. The membrane separation assemblies also include a feed header configured for supplying the feed flow to the plurality of membrane separation modules and a residual header configured for directing the residual flow out of and away from the plurality of membrane separation modules. Further, the membrane separation assemblies include a permeate flow directing system for directing the permeate flow external to the plurality of membrane separation modules. The plurality of membrane separation modules configured into the array are directly and fluidly coupled to one another such that the feed header supplies feed flow to all of the plurality of membrane separation modules and the residual header directs residual flow away from all of the plurality of membrane separation modules.

In yet another exemplary embodiment, a membrane separation assembly includes a plurality of membrane separation modules, each module of the plurality of membrane separation modules including a plurality of flat-sheet membrane elements configured for separating a feed flow into a residual flow and a permeate flow. The plurality of membrane separation modules are arranged into four parallel, vertically stacked rows, each row of the four parallel, vertically stacked rows including a plurality of membrane separation modules. Further, each of the plurality of membrane separation modules in a row of the four parallel, vertically stacked rows are oriented horizontally and parallel to one another. The membrane separation assembly also includes a feed flow directing system for directing the feed flow external to the membrane separation modules, the feed flow directing system including a feed header configured for supplying the feed flow to the plurality of membrane separation modules and positioned above the four parallel, vertically stacked rows. The membrane separation assembly also includes a residual flow directing system for directing the residual flow external to the plurality of membrane separation modules, the residual flow directing system including a residual header configured for directing the residual flow out of and away from the plurality of membrane separation modules and positioned below the four parallel, vertically stacked rows. Still further, the membrane separation assembly includes a permeate flow directing system for directing the permeate flow external to the plurality of membrane separation modules, the permeate flow directing system including a permeate header associated with each row of the four parallel, vertically stacked rows configured for directing the permeate flow away from the plurality of membrane separation modules. All of the four parallel, vertically stacked rows are directly and fluidly coupled with one another.

### BRIEF DESCRIPTION OF THE DRAWINGS

The membrane separation assemblies will hereinafter be described in conjunction with the following drawing figures, wherein like numerals denote like elements, and wherein:

FIG. 1 is a schematic illustration of a membrane element arrangement;

FIG. 2 is a schematic illustration of a membrane separation module including a plurality of membrane elements;

FIG. 3 is a schematic illustration of a conventional array of membrane separation modules;

FIG. 4 is a side view of a direct-coupled membrane separation assembly in accordance with one embodiment;

FIG. 5 is a segment of the direct-coupled membrane separation assembly of FIG. 4 viewed along plane 5-5;

FIG. 6 is a schematic illustration of a membrane separation module including a plurality of membrane elements configured for use in the direct-coupled membrane separation assembly of FIGS. 4 and 5;

FIG. 7 is a side view of a direct-coupled membrane separation assembly in accordance with another embodiment;

FIG. 8 is the direct-coupled membrane separation assembly of FIG. 7 viewed along plane 8-8;

FIG. 9 is a schematic illustration of a direct-coupled membrane separation assembly in accordance with a further embodiment;

FIG. 10 is a schematic illustration of a membrane separation module including a plurality of membrane elements in accordance with a further embodiment; and

FIG. 11 is a schematic illustration of a membrane separation module including a plurality of membrane elements in accordance with yet a further embodiment.

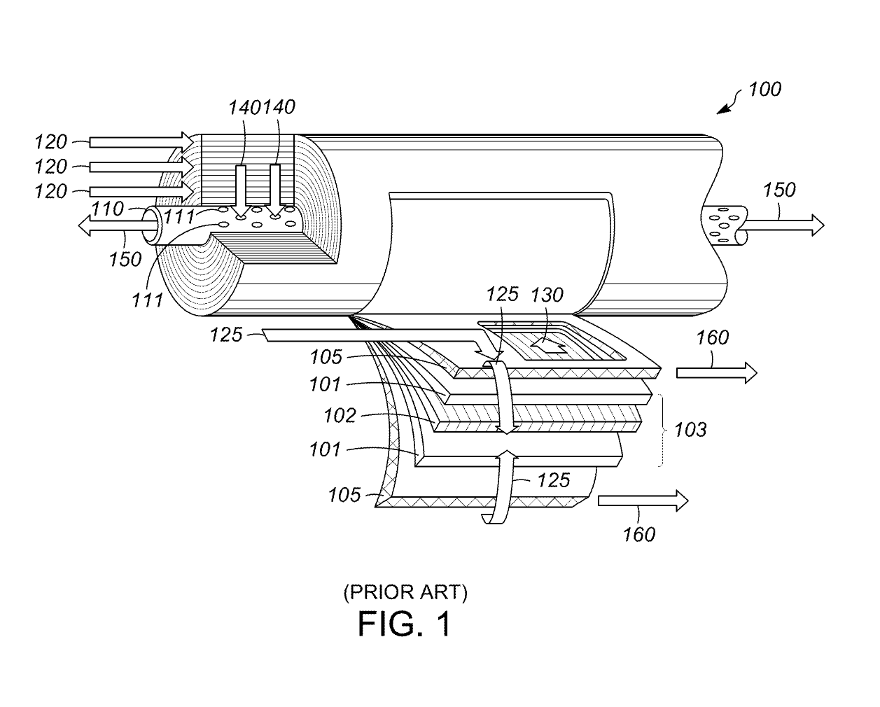

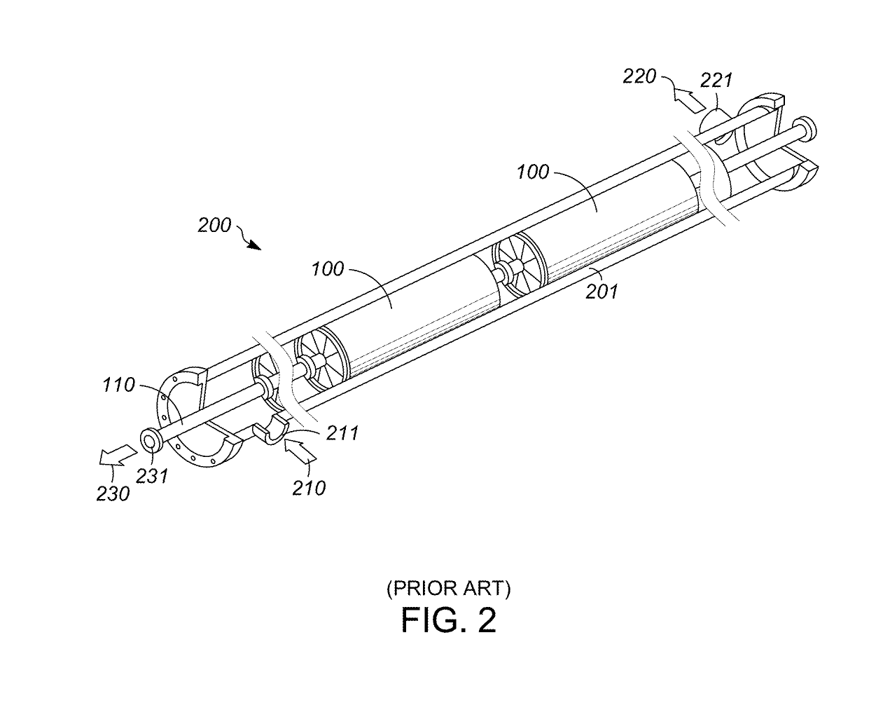

### DETAILED DESCRIPTION

The following detailed description is merely exemplary in nature and is not intended to limit the membrane separation assemblies or the application and uses of the membrane separation assemblies. Furthermore, there is no intention to be bound by any theory presented in the preceding background or the following detailed description.

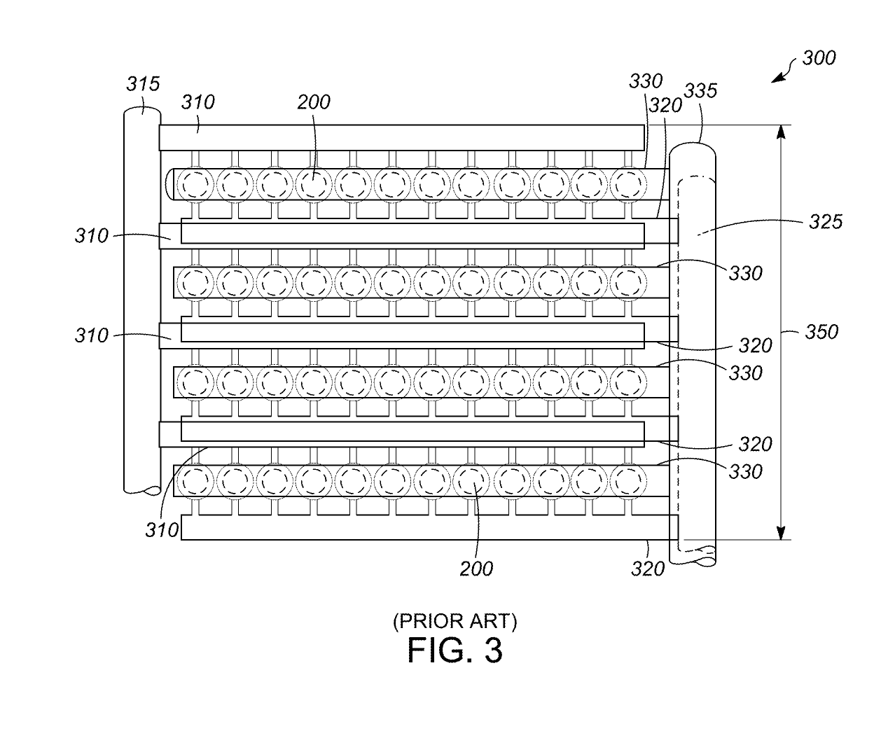

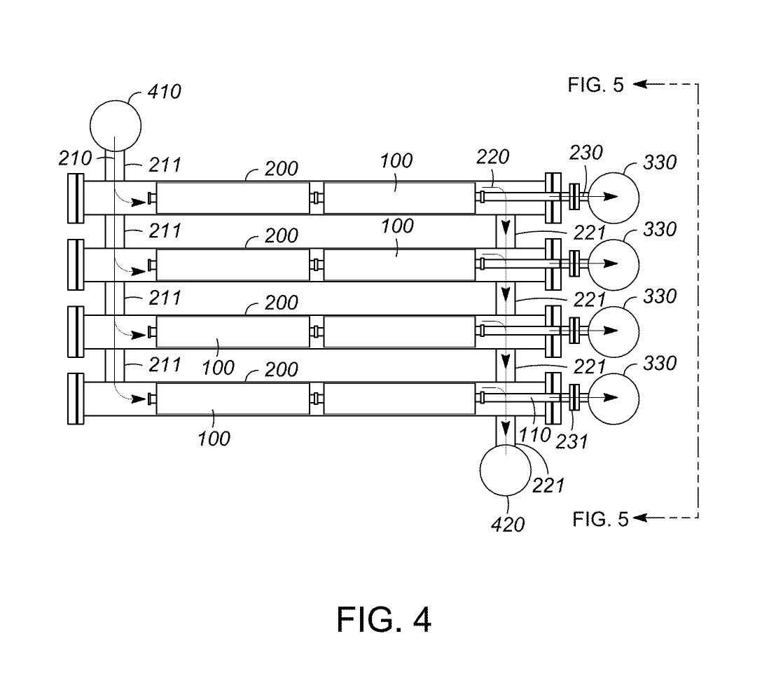

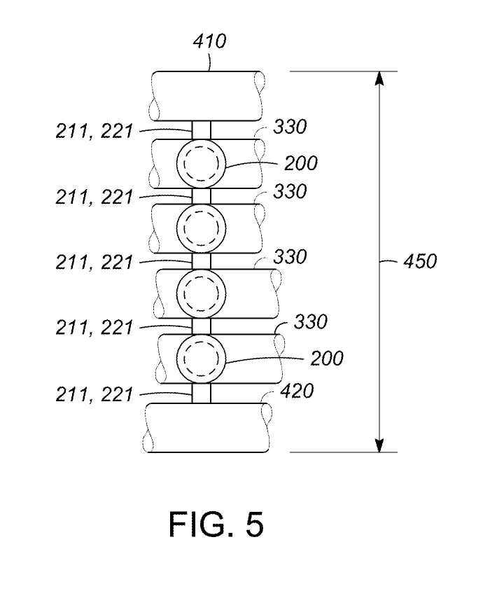

The various embodiments contemplated herein relate to improved membrane separation assemblies that beneficially require reduced installation space, are lighter, less expensive, and are easier to load with membrane elements than assemblies previously known in the art. In one embodiment, as shown in FIGS. 4 and 5 (FIG. 5 showing a single “segment” of the assembly of FIG. 4 for purposes of illustration), a membrane separation assembly is provided in a “direct-coupled” arrangement. As used herein, the terms “direct-coupled” or “directly and fluidly coupled” refers to an arrangement without a feed header or a residual header being positioned between the at least two of the parallel, vertically stacked rows. That is to say, as opposed to previously known assemblies wherein each row of modules 200 is connected to a separate perpendicularly oriented feed header 310 and a residual header 320 (see FIG. 3), the presently described direct-coupled arrangement directly couples or connects each row of modules 200 to one another via their respective feed ports 211 and residual ports 221, including only a single feed header 410 as the feed flow directing system and/or a single residual header 420 as the residual flow directing system.

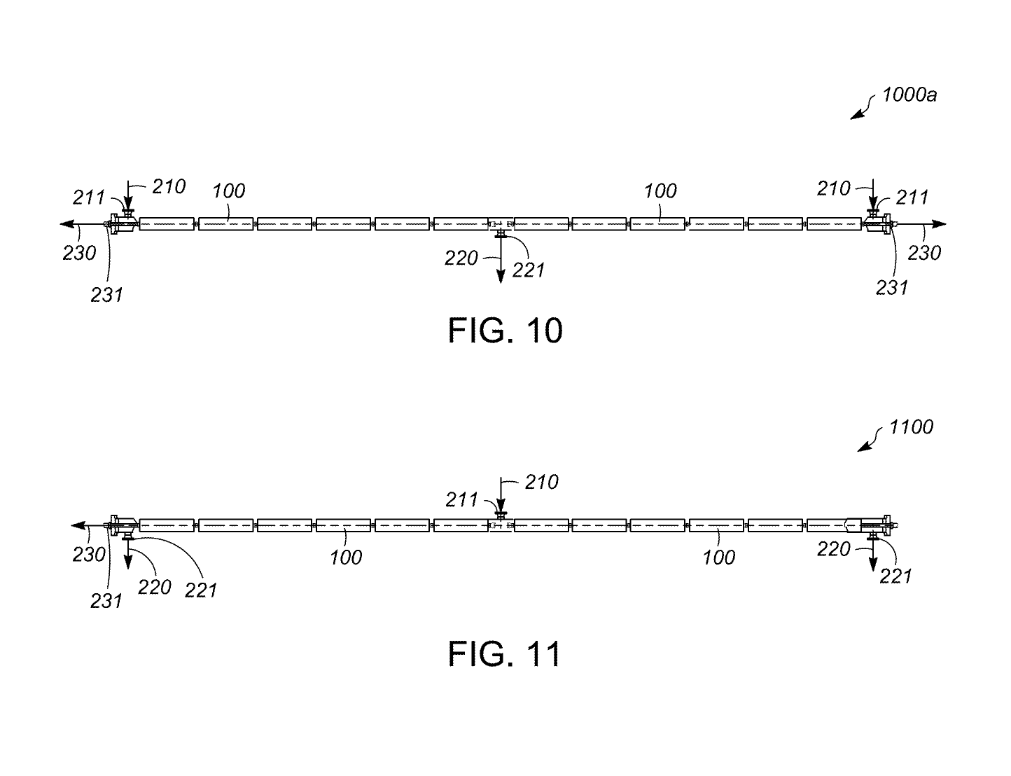

The embodiments that will be disclosed below with regard to FIGS. 4-9 include configurations where both a single feed header 410 and a single residual header 420 are employed. However, it will be appreciated that any of the embodiments disclosed with regard to FIGS. 4-9 could alternatively be designed to include modules 200 that are configured to accommodate a single feed header 410 and two residual headers 420, or two feed headers 410 and a single residual header 420, or to accommodate two permeate headers 330 in combination with any of the feed and residual header arrangements as will be described in greater detail below with regard to FIGS. 10-11. Furthermore, while the embodiments disclosed herein are directed to configurations where flow through the modules 200, the feed header(s) 410, and the residual header(s) 420 occurs in the horizontal plane, it will be appreciated that the assembly could be configured with flow in the vertical plane in one or more of the modules 200, the feed header(s) 410, or the residual header(s) 420.

As shown particularly in FIGS. 4 and 5, the single feed header 410 is positioned above the top row of modules 200, and configured in an orientation that is also horizontal, but perpendicular to the orientation of the modules 200 (similar to the top feed header 310, as shown in FIG. 3). In alternative embodiments, two feed headers 410 could be employed where the modules 200 are designed in accordance with FIG. 10, as will be discussed in greater detail below. In further alternative embodiments, the feed header(s) 410 and/or the modules 200 could be in a vertical orientation. The single residual header 420 is positioned below the bottom row of modules 200, and configured in an orientation that is also horizontal, but perpendicular to the orientation of the modules 200. Again, in alternative embodiments, two residual headers 420 could be employed where the modules 200 are designed in accordance with FIG. 11, as will be discussed in greater detail below. In further alternative embodiments, the feed header(s) 410 could be positioned below the array and the residual header(s) 420 above the array. In further alternative embodiments, the residual header(s) 420 could be in a vertical orientation. In this embodiment, the permeate flow assembly remains the same as in previously known arrays, including in each row one or two permeate header(s) 330 positioned in the plane of (in the vertical axis) the row, and configured in an orientation that is also horizontal, but perpendicular to the orientation of the modules 200. The feed header 410 and the residual header 420, in an exemplary embodiment, are made from steel to withstand the high pressures that are encountered in fluid separation operations, and are sized according to the pressure and flow rate to be processed by the assembly, for example about 4 inches to 18 inches.

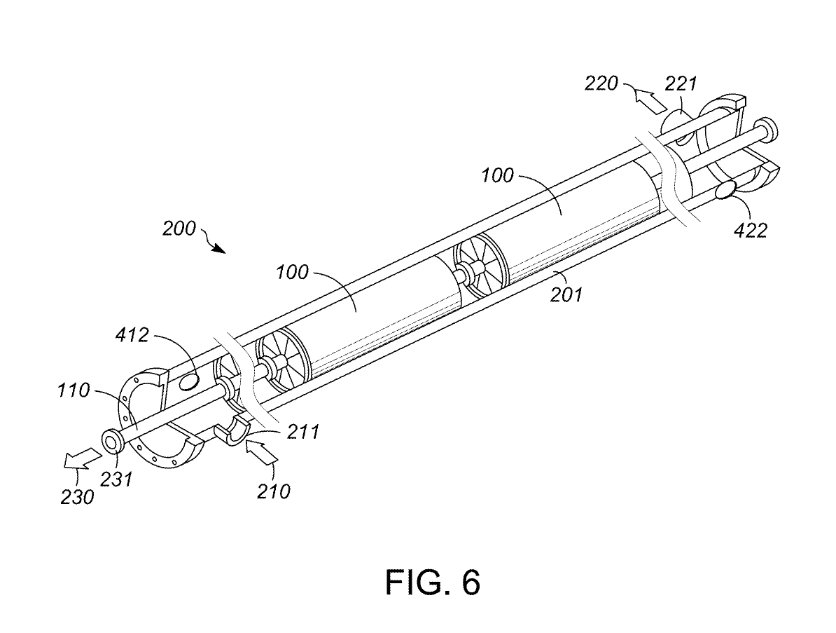

Each module's feed port 211 is connected to the module directly thereabove (or in the case of the top row modules, connected to the feed header 410). Each module's residual port 221 is connected to the module directly therebelow (or in the case of the bottom row modules, connected to the residual header 420). Referring momentarily to FIG. 6, an opening 412 is provided diametrically opposite the feed port 211 on all but the bottom row of modules for connectively receiving the feed port of the module positioned directly therebelow. An opening 422 is provided diametrically opposite the residual port 221 on all but the top row of modules for connectively receiving the residual port of the module positioned directly thereabove.

Referring to FIGS. 4, 5, and 6, in operation, a feed flow 210 is provided through the feed header 410 and flows into the top row of modules 200. From there, the feed flow passes through the openings 412 into the feed port 211 of the modules 200 in the row below. This flow pattern continues down successive rows, until the feed flow enters into bottom row of modules 200, which have no openings 412. A residual flow 220 exits each module through the residual port 221, and flows into the row of modules 200 successively therebelow through openings 422. This flow pattern continues down successive rows, until the feed flow exits the bottom row of modules 200, and into the residual header 420. It will be appreciated that the flow pattern would be altered accordingly where one or more of the modules 200, the feed header 410, or the residual header 420 are configured in a vertical orientation.

The presently described membrane separation assembly beneficially exhibits a significant reduction in vertical space requirements. That is, using the example of FIG. 3, a reduction of about 50 inches in vertical length can be achieved by eliminating the feed 310 and residual 320 headers positioned between horizontal rows of modules 100, and associated connection components. As shown in FIG. 5, an array having four rows of modules (as in FIG. 3) beneficially only requires a vertical length 450 of about 100 inches for installation. In many installation applications, particularly in offshore petrochemical processing applications, this vertical space reduction means that additional arrays can be provided using the same amount of total space for increased processing capacity. Further, the vertical space reduction provides for easier loading of the membrane elements into the modules. As will be appreciated by those having ordinary skill in the art, arrays of 150 inches in height or more are difficult to load with membrane elements because scaffolding would need to be provided for workers installing membrane elements into the top rows, as about 150 or more inches is generally out of the reach of a person of average height. With the reduction to about 100 inches in the presently described arrays, scaffolding is no longer required as a person of average height will be able to reach and install elements into the top rows of the array. This is particularly important for offshore applications, where such scaffolding is difficult to install, and may require workers to operate near the edge of the offshore platform. Still further, as the module tubes, headers, ports, and other components of the presently described arrays are preferably made from steel, which is a heavy and expensive metal, the significant reduction in the amount of steel components required (i.e., the intermediate feed and residual headers) results in a significant weight and cost reduction as compared to arrays previously known in the art. Furthermore, the presently described assemblies require fewer flanges, which will save time and money during membrane replacement and will reduce the number of potential leaks.

Prior to the inventors' conception of the present invention, it was previously understood in the art that feed and residual headers between rows of modules were required for successful operation of the membrane separation assembly due to the fact that conventional engineering judgment would lead a person having ordinary skill in the art to conclude that the resulting flow would be uneven, resulting in significantly degraded separation performance. However, the inventors have unexpectedly discovered, with the use of novel flow modeling techniques, that in fact performance degradation may be reduced or minimized where the number of membrane elements in a tube is such that the pressure drop is, for example, at least about 40 times greater than the pressure drop through the most restrictive direct coupled port, such as about 50 times greater. As such, by configuring the assemblies in accordance with the particular configurations described herein, and others as will be appreciated by those having ordinary skill in the art upon reading this disclosure, a reduction in vertical height by elimination of intermediate headers has been found to be possible without significant degradation in the processing and flow characteristics within the modules of the array. It is expected that pressure drops as set forth above can be implemented in configuration with between 2 and about 20 rows, or any number of rows thereinbetween. However, the array is preferably implemented with between 2 and 10 rows, or any number thereinbetween, or more preferably between 2 and 5 rows, or any number thereinbetween, to achieve the installation benefits discussed above.

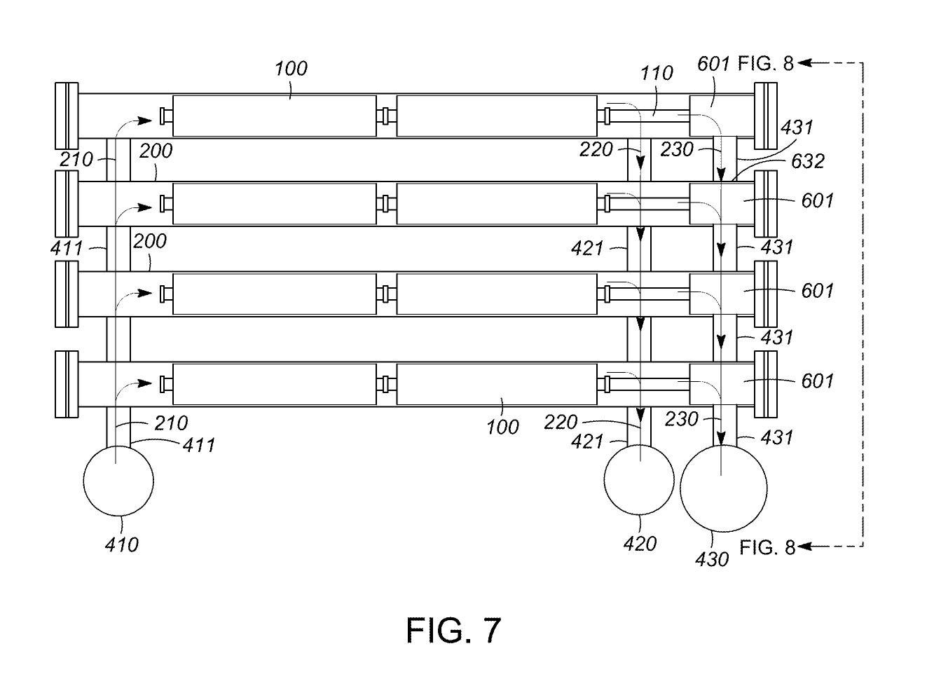

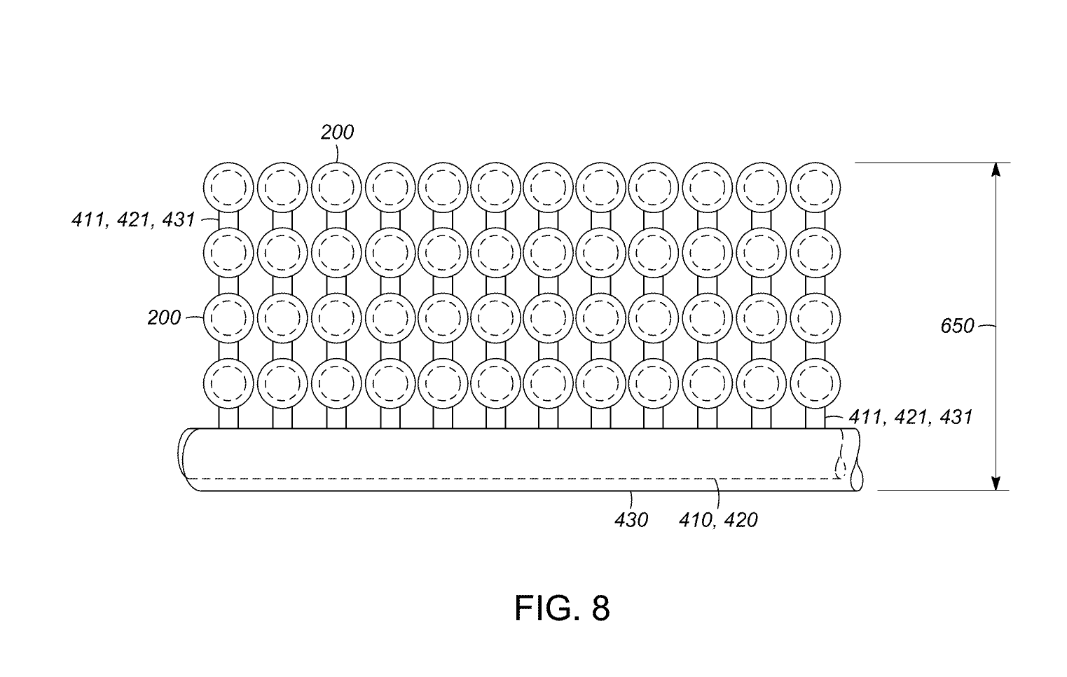

In another embodiment, as shown in FIGS. 7 and 8, both the feed header 410 and the residual header 420 are located at the bottom of the array, thus saving additional vertical space due to the elimination of the feed header at the top of the array, and the associated feed port 211 and connections (see FIGS. 4 and 5). Of course, variations of this embodiment will be possible with either two feed headers 410 or two residual headers 420 or with permeate collected on both ends in permeate headers 330 or 430. In this embodiment, the vertical length 650 required for installation is about 85 inches. In this embodiment, the feed ports 211 of the modules 200 extend below each module 200, and an opening 412 is provided diametrically opposite the port 211 for connective association with the port 211 of the module 200 located thereabove. Further, in this embodiment, the top-row modules 200 do not include an opening 412. In an alternative configuration of this embodiment, both the feed header 410 and the residual header 420 are located at the top of the array (saving a similar amount of vertical space). In this alternative, the residual ports 221 of the modules 200 extend above each module 200, and an opening 422 is provided diametrically opposite the port 221 for connective association with the port 211 of the module 200 located therebelow. Further, in this alternative, the bottom-row modules 200 do not include an opening 422. It is presently contemplated that in some installations, this alternative may require automatic or manual drain valves to be provided at one or more low points along the array to ensure that feed or residual flow does not stagnate near the bottom of the array.

In yet another embodiment, as further shown in FIGS. 7 and 8, the permeate flow directing system may be reconfigured such that the four horizontally oriented permeate headers 330 are eliminated in favor of one or two permeate header(s) 430 positioned below the array. Due to the change in the direction of the permeate flow 230 at the ends of the modules 200, flow adapters 601 are required to redirect the flow from the horizontally oriented permeate tube 110 vertically downward and into a repositioned permeate port 431 at the bottom of the module 200. An exemplary flow adapter 601 that can be configured for use in accordance with the present disclosure is described in commonly-assigned U.S. Patent Application Publication No. 2009/0084725, published Apr. 2, 2009 (“Permeate Adapter for Multi-Tube Pressure Vessel”, inventors S. Poklop et al.). The flow adapters 601 include an opening 632 for connectively receiving the permeate port 431 from the module located directly thereabove. The top row of modules 200 will not include such an opening 632. In this embodiment, the single permeate header 430 is provided having a diameter that is larger than the individual permeate headers 330 to accommodate the increase in permeate flow 230 over the previously described embodiment. For example, the single permeate header 430 can be between about 6 inches and 24 inches in diameter. Alternatively, the permeate header(s) 430 could be positioned above the array, in the manner as described above with regard to the alternative residual header 420 configuration, wherein a feed header 410 and a residual header are located above the array. Alternatively, the permeate header(s) can also be oriented vertically.

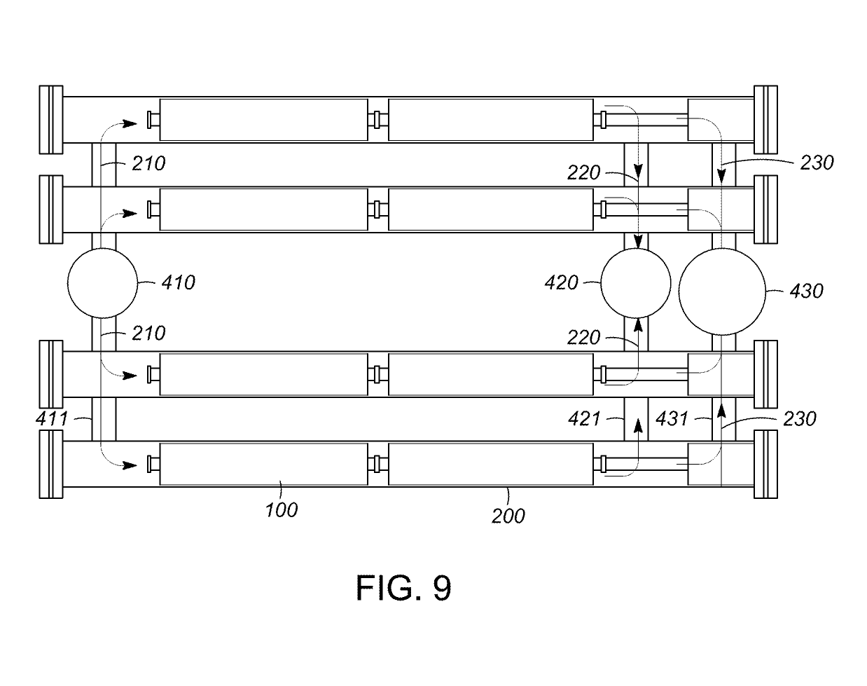

In still a further embodiment, as shown in FIG. 9, the feed header(s) 410 and the residual header(s) 420 (and optionally the permeate header(s) 430, as is shown in FIG. 9) can be provided horizontally between two module rows such that between two and ten, preferably between two and five, module rows are located above the headers 410 and 420 and between two and ten, preferably between two and five, module rows are located below the headers 410 and 420. Of course, variations of this embodiment will be possible with either two feed headers 410 or two residual headers 420 or with the headers 410, 420 and 430 in a vertical orientation. For any rows located above the headers 410 and 420, the flow configuration will be made and the flow will proceed according to the embodiment of FIGS. 7 and 8, wherein the feed flow proceeds upwardly through each successive module via openings 412 and ports 211, and the residual flow proceeds downwardly through each successive module via openings 422 and ports 221. For any rows located below the headers 410 and 420 (and optionally 430), the flow configuration will be made and the flow will proceed according to the embodiment described in the alternative with reference to FIGS. 4 and 5 and with reference to FIGS. 7 and 8, wherein the feed flow proceeds downwardly through each successive module via openings 412 and ports 211, and the residual flow proceeds upwardly through each successive module via openings 422 and ports 221.

With reference to any of the previously described embodiments, it is generally anticipated that one having ordinary skill in the art, based on the foregoing disclosure, will be able to configure a direct-coupled array having the single feed header positioned above the array, below the array, or between rows of the array, and the single residual header positioned above the array, below the array, or between rows of the array. Further, one having ordinary skill in the art, based on the foregoing disclosure, will be able to configure a direct-coupled array having either the conventionally designed permeated header configuration (as shown in FIG. 3), or optionally a single permeate header positioned above the array, below the array, or between rows of the array. Further, it is anticipated that one having ordinary skill in the art, based on the foregoing disclosure, will be able to configure a direct-coupled array using either co-current or counter-current permeate flow. Still further, it is anticipated that one having ordinary skill in the art, based on the foregoing disclosure, will be able to configure a direct-coupled array having one, two, three, four (as shown in the examples), or more rows of tubes.

In further embodiments, membrane assemblies may be configured with alternatively two feed headers 410 or two residual headers 420. As shown in FIG. 10, a membrane module 1000a is provided including two feed ports 211 located on either end of the module 1000a, with a single residual port 221 located along the module in position between the two feed ports 211 (the single residual port 221 is shown positioned between equal numbers of elements 100, but this need not be so in all implementations). Furthermore, as shown in FIG. 11, a membrane module 1100 is provided including a single feed port 211 and two residual ports 221. The single feed port is located along the module in position between the two residual ports 221 (the single feed port 211 is shown positioned between equal numbers of elements 100, but this need not be so in all implementations). In module 1000a, two permeate ports 231 are provided, whereas in module 1100, a single permeate port is provided. In general, any of the modules disclosed herein can be provided with one or two permeate ports 231 or 431. The resulting assemblies will therefore need to be alternatively configured with one or more headers 330 or 430 on one end of the modules (as shown in the above exemplary embodiments), or one or more permeate headers 330 or 430 on both ends of the modules (as would be required for an implementation in accordance with, for example, FIG. 10). Furthermore, while the embodiments disclosed herein are directed to configurations where flow through the modules 200, the feed header(s) 410, the residual header(s) 420, and permeate header(s) 430 occurs in the horizontal plane, it will be appreciated that the assembly could be configured with flow in the vertical plane in one or more of the modules 200, the feed header(s) 410, the residual header(s) 420 or the permeate header(s) 430.

Accordingly, improved membrane separation assemblies have been described. The improved membrane separation assemblies beneficially incorporate an increased number of membrane modules in a given area to allow for increase processing capabilities in space-restrictive installations. Furthermore, the improved membrane separation assemblies are desirably less cumbersome and/or less expensive to manufacture and install. Still further, the improved membrane separation assemblies have simplified process fluid stream connections that reduce the number of heavy steel components required in the assembly.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the processes without departing from the scope defined by the claims, which includes known equivalents and foreseeable equivalents at the time of this disclosure.

What is claimed is:

1. A membrane separation assembly comprising:
a plurality of membrane separation modules, each module of the plurality of membrane separation modules comprising a plurality of membrane elements configured for separating a feed flow into a residual flow and a permeate flow, wherein the plurality of membrane separation modules are arranged into between two and twenty rows, each row comprising a plurality of membrane separation modules, and wherein each of the plurality of membrane separation modules in a row are oriented parallel to one another;
a feed flow directing system for directing the feed flow external to the membrane separation modules, the feed flow directing system comprising:
one or two feed headers configured for supplying the feed flow to the plurality of membrane separation modules;
a residual flow directing system for directing the residual flow external to the plurality of membrane separation modules, the residual flow directing system comprising:
one or two residual headers configured for directing the residual flow away from the plurality of membrane separation modules; and
a permeate flow directing system for directing the permeate flow external to the plurality of membrane separation modules;
wherein at least two of the rows are directly and fluidly coupled with one another.

2. The membrane separation assembly of claim 1, wherein the plurality of membrane separation modules are arranged into four parallel, vertically stacked rows.

3. The membrane separation assembly of claim 2, wherein at least three of the four parallel, vertically stacked rows are directly and fluidly coupled with one another without a feed header or a residual header being positioned between the at least three of the four parallel, vertically stacked rows.

4. The membrane separation assembly of claim 2, wherein all of the four parallel, vertically stacked rows are directly and fluidly coupled with one another without a feed header or a residual header being positioned between the four parallel, vertically stacked rows.

5. The membrane separation assembly of claim 1, wherein the plurality of membrane separation modules are arranged into five parallel, vertically stacked rows.

6. The membrane separation assembly of claim 1, wherein the feed flow directing system comprises one or two feed headers and wherein the residual flow directing system comprises a one or two residual header.

7. The membrane separation assembly of claim 1, wherein the feed flow directing system and the residual flow directing system are positioned both above the rows, both below the rows or one above and one below the rows.

8. The membrane separation assembly of claim 1, wherein at least two of the rows are directly and fluidly coupled with one another without a feed header or a residual header being positioned between the at least two of the rows.

9. The membrane separation assembly of claim 1, wherein the feed flow directing system and the residual flow directing system are positioned above at least one row and below at least one row.

10. The membrane separation assembly of claim 1, wherein each of the plurality of membrane separation elements comprises a flat-sheet arrangement.

11. The membrane separation assembly of claim 1, wherein the permeate flow directing system comprises a permeate header associated with one or both sides of each row and is configured for directing the permeate flow out of and away from the plurality of membrane separation modules.

12. The membrane separation assembly of claim 11, wherein the one or two feed headers, the one or two residual headers, and the permeate headers each have a diameter in the range of about 4 inches to about 18 inches.

13. The membrane separation assembly of claim 1, wherein the permeate flow directing system comprises one or two permeate headers configured for directing the permeate flow out of and away from the plurality of membrane separation modules.

14. The membrane separation assembly of claim 13, wherein the one or two feed headers and the one or two residual headers each have a diameter in the range of about 4 inches to about 18 inches, and wherein the single permeate header has a diameter in the range of about 6 inches to about 24 inches.

15. The membrane separation assembly of claim 1, wherein the feed header and the residual header comprise steel.

16. The membrane separation assembly of claim 1, wherein the plurality of membrane separation modules are oriented vertically to provide vertical flow therethrough.

17. A membrane separation assembly comprising:
a plurality of membrane separation modules configured into an array, each module of the plurality of membrane separation modules comprising a plurality of membrane elements configured for separating a feed flow into a residual flow and a permeate flow;
a single feed header configured for supplying the feed flow to the plurality of membrane separation modules;
a single residual header configured for directing the residual flow out of and away from the plurality of membrane separation modules; and
a permeate flow directing system for directing the permeate flow external to the plurality of membrane separation modules;
wherein the plurality of membrane separation modules configured into the array are directly and fluidly coupled to one another such that the single feed header supplies feed flow to all of the plurality of membrane separation modules and the single residual header directs residual flow away from all of the plurality of membrane separation modules.

18. The membrane separation assembly of claim 17, wherein the permeate flow directing system comprises a plurality of permeate headers for directing the permeate flow away from the plurality of membrane separation modules.

19. The membrane separation assembly of claim 17, wherein the permeate flow directing system consists essentially of a single permeate header for directing the permeate away from the plurality of membrane separation modules.

20. A membrane separation assembly, comprising:
a plurality of membrane separation modules, each module of the plurality of membrane separation modules comprising a plurality of flat-sheet membrane elements configured for separating a feed flow into a residual flow and a permeate flow, wherein the plurality of membrane separation modules are arranged into four parallel, vertically stacked rows, each row of the four parallel, vertically stacked rows comprising a plurality of membrane separation modules, and wherein each of the plurality of membrane separation modules in a row of the four parallel, vertically stacked rows are oriented horizontally and parallel to one another;
a feed flow directing system for directing the feed flow external to the membrane separation modules, the feed flow directing system comprising:
a single feed header configured for supplying the feed flow to the plurality of membrane separation modules and positioned above the four parallel, vertically stacked rows;
a residual flow directing system for directing the residual flow external to the plurality of membrane separation modules, the residual flow directing system comprising:
a single residual header configured for directing the residual flow out of and away from the plurality of membrane separation modules and positioned below the four parallel, vertically stacked rows; and
a permeate flow directing system for directing the permeate flow external to the plurality of membrane separation modules, the permeate flow directing system comprising a permeate header associated with each row of the four parallel, vertically stacked rows configured for directing the permeate flow away from the plurality of membrane separation modules;
wherein all of the four parallel, vertically stacked rows are directly and fluidly coupled with one another.
